(19) United States
(12) Patent Application Publication
(10) Pub. No.: US 2024/0280708 A1
(43) Pub. Date: Aug. 22, 2024

(54) Operating Method for Determining Navigation Data, Navigation Module, Computer Program Product and Machine-Readable Storage Medium

(71) Applicant: Robert Bosch GmbH, Stuttgart (DE)

(72) Inventors: Markus Langer, Sachsenheim (DE); Alexander Metzger, Rottenacker (DE)

(21) Appl. No.: 18/563,264

(22) PCT Filed: Apr. 27, 2022
(86) PCT No.: PCT/EP2022/061222

§ 371 Date: Nov. 21, 2023

(30) Foreign Application Priority Data
May 26, 2021 (DE) 10 2021 205 330.0

(51) Int. Cl. G01S 19/39; G01S 19/40

(52) U.S. Cl. CPC G01S 19/393; G01S 19/40

(57) ABSTRACT

An operating method for determining navigation data based on global navigation satellite system (“GNSS”) data in a navigation module includes receiving GNSS data, and determining navigation data with the GNSS data using stored parameters that are saved in a memory of the navigation module and that have been ascertained from GNSS data using at least one filter. The method further includes extracting a criterion from the navigation data or from another data source, which criterion identifies a special situation in which reception of GNSS data is influenced by an error situation that is constantly present at least temporarily or has at least one constant component. The method also includes performing updates and/or corrections to stored parameters using the at least one filter for subsequent determinations of navigation data.

### PRIOR ART

GNSS-based methods for determining navigation data (positions/speeds etc.), which are carried out in GNSS receivers or in navigation modules comprising GNSS receivers, determine positions based on triangulation using the distances between the GNSS receiver and the GNSS satellites. The distances are calculated by determining the transit times of signals from each individual GNSS satellite to the GNSS receiver, taking into account the propagation speed of the signals on the path from the GNSS satellite to the GNSS receiver. The signals received by the GNSS receiver from the GNSS satellites are referred to below as GNSS data. The transit times are determined by very precise measurements of the times at which the signals arrive at the GNSS receiver. The calculated distances are referred to as “pseudo-distances” or “pseudo-ranges” because the distances are actually falsified by many sources of error and special features and usually only partially correspond to actual distances between the GNSS receiver and the GNSS satellites. These sources of error must be corrected in GNSS-based navigation data determination methods. A particularly important source of error to be emphasized here, which should be taken into account in navigation data determination methods, are so-called clock errors, which can occur in the GNSS receiver and/or in GNSS satellites and which can influence the time measurement regarding the time of transmission of signals by the GNSS satellites as well as the time of reception of signals by the GNSS receiver.

Depending on the respective application, the desired robustness, accuracy and integrity, there are various approaches for determining navigation data. Some exclusively use the pseudo distances described above. Other more complex approaches additionally utilize carrier band phase information for high-precision distance determination and/or correction data provided by external correction data service providers. Almost all approaches have in common that unknown elements (errors, bias, noise, etc.) are taken into account or estimated in order to increase the accuracy of the determination of navigation data. The following (non-exhaustive) list provides an overview of known error correction methods:
consideration of clock errors (especially receiver clock errors),
code and/or phase shifts caused by signal processing in the GNSS satellite,
code and/or phase shifts caused by signal processing in the GNSS receiver,
time differences between the clocks of the GNSS system (errors between clocks of different GNSS satellites of the GNSS system),
band shifts between the participants in the GNSS system (GNSS satellites and GNSS receivers), especially errors caused by the use of different frequency bands
phase shifts between the participants in the GNSS system (GNSS satellites and GNSS receivers), in particular errors due to signals at different frequencies. Such errors affect the glonass system in particular, which always transmits on different frequencies for each satellite;
ionospheric errors, concerning influences on signal processing speeds in the ionosphere,
tropospheric errors, concerning influences on signal processing speeds in the troposphere, or
orbit data errors that contain incorrect or inaccurate data concerning the orbits of GNSS satellites and thus cause a misjudgment of the actual position of satellites.

Each of these error correction methods is usually realized in the form of parameters and/or specific correction rules for processing such correction parameters to correct the pseudo-distances or the navigation data. Parameters and correction rules are usually saved as parameters in a GNSS receiver/navigation module and are executed by filters. The so-called correction data, which are provided from an external correction data source and which relate in particular to orbital data and to data concerning the ionosphere and the troposphere, are a subset of such parameters.

In most applications, these parameters are determined as a continuous process in parallel with the permanent determination of current navigation data. There are normally different update time intervals for different types of parameters (depending on which error correction affects the individual parameters). This can be defined, for example, in the form of an update frequency or an update interval for each parameter and/or for each individual correction rule. The update frequency or update interval can be adjusted individually depending on other data. In many cases, the regular updating of parameters is implemented using filters that take into account historical data and newly available information (new correction data and/or update parameters for parameters and/or parameters obtained from observations of GNSS data) and, based on this, enable the calculation of new parameters for actual use in the determination of navigation data, taking into account the history. One possible filter concept for such filters is the so-called Kalman filter. The use of a Kalman filter is also realized in particular in highly integrated navigation modules comprising GNSS receivers and set up for processing GNSS data into navigation data. In addition to GNSS data, such highly integrated navigation modules also evaluate data from other sensor sources to determine navigation data. Other sensor sources can be, for example, inertial sensors or wheel speed sensors or other sensors that provide useful information for determining navigation data.

There are environmental conditions that are difficult to estimate and model and that cause a significant distortion of estimates and/or reception of such parameters. Such environmental conditions include, in particular, so-called multipath propagations or multiple transmissions of signals (so-called “multipath environments”), which can result in particular from the spatial situation in the immediate vicinity of a GNSS receiver. Such multipath propagation or multiple transmissions can result, for example, from surrounding buildings or other objects that lead to signal reflections or distortions in the vicinity of the GNSS receiver, so that signals are received indirectly and/or multiple times due to partial reflections.

### DISCLOSURE OF THE INVENTION

In the following, a new method will be described which is used to ascertain correction data for the determination of navigation data in a navigation module:

Operating method for determining navigation data based on GNSS data in a navigation module is to be described here, comprising the following steps:
a) receiving GNSS data,
b) determining navigation data with the GNSS data using stored parameters saved in a memory of the navigation module, which were ascertained from GNSS data (1) with at least one filter (2, 3),
c) extracting a criterion from the navigation data or from another data source, which identifies a special situation, in which a reception of GNSS data is influenced by an error situation, which is present at least secondarily constant or has at least a constant component,
d) performing updates and/or corrections of stored parameters for subsequent determinations of navigation data according to step b), wherein at least for parts of stored parameters that change fundamentally slower during operation than other stored parameters, the update and/or correction is slowed down or even suspended if the criterion extracted in step c) indicates such a special situation.

The method is particularly advantageous if the special situation is a situation in which unfavorable environmental conditions for the reception of GNSS data are present as an error situation. By a temporarily constant error situation or an error situation that has at least a constant component, it is meant that the error does not occur temporarily and then disappear again, or in a given case even errors that cancel each other out appear. A constant error situation occurs, for example, due to an obstacle to reception that is uniformly present on a certain side of a GNSS antenna. In order to characterize a partial constancy of the error situation, it is sufficient, for example, if the error situation changes only slowly (in a given case first building up and then decreasing again).

Such a situation with unfavorable environmental conditions as a special situation can be identified on the basis of values contained in the navigation data and/or at least a probability that such a situation exists can be ascertained. For example, the navigation data can contain position information relating to the current position of the navigation module/GNSS receiver as a value, and this position information can then be used to identify that a situation with unfavorable environmental conditions is likely to exist.

The method described increases the robustness and accuracy of the determination of stored parameters, especially in complex environments (e.g. environments with multipath propagation). The method is particularly suitable in situations in which systematic errors occur in correction data, which have a major effect on the accuracy of the determination of position data. The method described here can also be used for applications in which GNSS data is fused with other data (e.g. with sensor data such as wheel speed sensor data and/or data from one or more inertial sensors). Fusion often enables much more accurate navigation data to be generated for such applications.

The stored parameters used to determine navigation data usually have specific inherent properties, such as noise components, error probabilities, possible or expected rates of change and similar quantities. These properties of the stored parameters are normally taken into account when determining navigation data.

The concept of the method described here relates in particular to a set of stored parameters that a navigation module uses to determine its position. Slowing down or even suspending the update and/or correction in step d) affects only some of these stored parameters

The concept of the method described here is a specific treatment or a special determination of such stored parameters that are subject to slower changes (i.e. only minor changes) over time compared to other correction data. An example of such slowly changing correction data is a time offset between different GNSS satellites of two GNSS satellite constellations (e.g. between GPS satellites and Galileo satellites). For example, such a time shift changes very slowly or very little compared to a time shift between GNSS satellites and the respective GNSS receiver. However, in specific error situations, there is an increased risk that a systematic error will be imprinted on such parameters, which will level out again later only after a longer operating period when the error situation no longer exists. Such error situations can be predicted on the basis of special situations. If a special situation is, for example, a standstill start or a slow drive in the city, then there is an increased probability that certain situations of multipath signal propagation are present that represent an error situation.

The method described comprises updating and/or correcting stored parameters in step d) using GNSS data.

This is possible, for example, if one such parameter is a described time offset that is estimated based on GNSS signals.

The method is further advantageous if updated correction data and/or update parameters for stored correction data are regularly retrieved from an external source.

The method described here basically involves two approaches, namely to slow down the adaptation of slowly changing stored parameters when the special situation described is present or to keep these slowly changing stored parameters completely constant in such special situations. If necessary, both approaches can also be combined so that the adjustment for some of the parameters is slowed down and another part of the parameters is kept completely constant.

The method described is particularly advantageous if, in order to determine the criterion, it is determined whether a start phase of the navigation module is present and a special situation is detected in a start phase of the navigation module.

The start phase can either be identified from the navigation data of the navigation module itself or other data sources can be used for this, such as parameters and/or flags from other control units that are external, i.e. not located within the navigation module.

This approach is particularly advantageous during the start-up phase of GNSS receiver operation because the GNSS receiver cannot then access information that is already available. During start-up phases, there is a particularly high risk of stored parameters being falsified even after the start-up phase due to incorrect updates and/or corrections to the correction data.

In this phase in particular, there is therefore a risk that erroneous GNSS data/GNSS signals can cause a strong distortion of the correction data. On the other hand, if the stored parameters change slowly, it can be assumed that updating and/or correcting the correction data in real time is not necessary or is less urgent than for parameters that change more quickly. At the same time, incorrect parameter adjustments due to erroneous GNSS data/GNSS signals received are more difficult to correct in the future with such slowly changing stored parameters or it takes longer until new adjustments/corrections with correct (not erroneous GNSS signals) have a positive effect on the correction data or correct them again.

The method is also advantageous if the criterion is defined in such a way that it describes a special situation that describes a static scenario for the operation of the navigation module.

In this context, it is particularly advantageous if a speed at which the navigation module is moving is first determined to determine the criterion and a special situation is detected if the speed is below a threshold value.

This particularly advantageous implementation or application of the described method is based on the fact that slowly changing stored parameters (e.g. stored parameters relating to the offset between different GNSS satellite constellations) should be adjusted only if the receiver is moving at a speed greater than a certain limit value. This approach considerably increases the overall robustness of the provision of navigation data with a navigation module and this applies in particular to difficult conditions, such as the situation described above with multipath propagation of the signals, for example in an urban environment. In such an environment, errors due to multipath preparation have a very large effect on the accuracy of the specific navigation data. This effect on the error is particularly greater than in a scenario with highly dynamic position data, which occurs at high speeds, for example. In a static scenario with multipath propagation of the signals, there is a particularly high probability of obtaining a systematic error or a systematic shift in the GNSS data received and processed with a GNSS receiver (especially in the GNSS signals) than in a scenario with high dynamics. One reason for this is that in a scenario with high dynamics, there are usually many effects that level out errors or different influences cancel each other out. By suppressing corrections/adjustments of slowly changing parameters in static scenarios (characterized by an upper speed threshold), the overall quality of the update of slowly changing parameters can be significantly increased and the effect of problematic scenarios (especially problematic environments) is reduced.

In other words: If the GNSS receiver is moving at a high speed, it is unlikely that it will be in an unfavorable situation for a longer period of time, causing a systematic error. For this reason, it is helpful in such situations to suppress or at least slow down the corrections/adjustments of parameters.

The method described and the adjustments relating to slowly changing stored parameters also benefit the accuracy of rapidly changing stored parameters, which are usually also determined and permanently corrected or adjusted in parallel. This is the case because both the determination/correction/adjustment of slowly changing parameters and the determination/correction/adjustment of rapidly changing parameters usually take place in parallel and build on each other—possibly even in a common filter. The lower errors that occur when determining slowly changing parameters using the described method therefore also have a positive effect, at least indirectly, on the determination of rapidly changing parameters. Overall, the entire process for determining navigation data (position data/speed data/etc.) is therefore improved.

In addition to the speed, other criteria can also be defined which are used as a criterion for suppressing the influence of slowly changing parameters during updates and/or corrections. The basic principle of the method described here is to adjust/correct different parameters with different frequencies/repeat rates.

It is particularly advantageous to update and/or correct stored parameters in step d) using a filter.

With a filter, it is possible to process update data and/or new parameters together with stored, historical parameters in such a way that a continuous adjustment of the parameters used for the provision of navigation data takes place.

It is particularly advantageous if step b) is carried out by a main filter and step d) by a separate filter that is separate from the main filter.

Separate filters here means that the filters influence each other, but preferably the internal states of the main filter are not taken into account by the separate filter and vice versa. However, the memories can influence each other via their inputs and outputs, wherein outputs of one filter are inputs of the other filter and vice versa. The implementation with separate filters enables simple, targeted influencing of the separate filter. The separate filter prefers to process only the slowly changing stored parameters affected here.

It is particularly preferable if at least the main filter and/or the separate filter is a Kalman filter.

A Kalman filter is particularly suitable for carrying out the method described here, as it contains a history of past observations and can provide particularly good estimates for parameters based on this.

It is also advantageous if the separate filter is slowed down if a special situation can be determined on the basis of the criterion extracted in step c).

A slowdown here refers in particular to a reduction in the speed at which the separate filter makes or can make changes to the parameters. A slowdown is in particular a slowdown compared to a regular processing speed. A slowdown can be achieved, for example, by reducing a maximum permissible change (specified as a percentage or as an absolute value) for a parameter. The separate filter can then no longer change the parameter as much per processing step and the filter is thus slowed down. A slowdown can also be achieved by extending the time interval between processing steps of the filter. Technically, many different concepts for slowing down the filter are possible.

According to one approach for implementing the method described, the adjustment of slowly changing parameters is carried out in a separate filter. The main filter, which estimates the other parameters and usually also ascertains navigation data (positions/speeds etc.), is not responsible for updating and/or correcting the slowly changing parameters. The updating and/or correction of time deviations between clocks of GNSS satellites of different GNSS constellations can, for example, be excluded from the main filter. These adjustments are made with the separate filter and transferred to the main filter from input.

With this design variant, it is very easy to temporarily slow down or even completely suppress the updating/adjustment of slowly adapting stored parameters. This can be achieved in particular by a lower weighting of received data (in particular update parameters and received correction data, especially preferably extracted from GNSS signals, GNSS data, GNSS signals) in or with the additional filter.

Many other design variants and improvements are possible. Filters that estimate all necessary stored data and are capable of selectively slowing down updates and/or correcting individual stored parameters are conceivable. The method described is not limited to a specific arrangement of filters.

It is only necessary to ensure that possibly erroneous GNSS data (e.g. GNSS signals in a multipath situation) are not taken into account or taken into account only to a small extent when adjusting/correcting parameters which change very slowly over time anyway. The overall accuracy of the determination of navigation data is then increased.

Also described here is a navigation module set up to carry out the method described.

In addition, a computer program product is to be presented which is set up to carry out the method steps according to the method described, as well as a machine-readable storage medium on which the computer program product is stored.

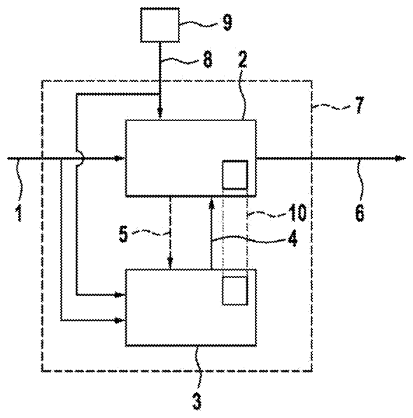

The method described and the technical environment are explained in more detail below with reference to the FIGURE. FIG. 1 shows a preferred embodiment example but to which the method is not limited. Shown are:

FIG. 1: A filter concept for carrying out the method described,

FIG. 1 shows a navigation module 7, which is set up to carry out the method described. The navigation module 7 receives GNSS data 1, which can in particular comprise GNSS signals, and it provides navigation data 6 based on the GNSS data 1. As an example, it is shown that the navigation module 7 can also process further data 8, which can, for example, originate from further (optionally also GNSS-external) sensors 9, such as inertial sensors, speed-based speed sensors, etc. The navigation module 7 has a main filter 2 which processes the GNSS data 1 and generates the navigation data 6. The GNSS data 1 is additionally transmitted to the separate filter 3, which extracts the slowly adjusted parameters 4 from the GNSS data and provides them to the main filter 2. The separate filter 3 can be set to slow down or even suppress the adjustment/correction of the slow-adjusting parameters 4. The separate filter 3 is set up so that it performs the braking and/or suppression of the adjustment/correction as a function of the criterion 5 itself, which is preferably provided by the main filter 2. The criterion 5 is extracted from the navigation data 6 and indicates a special situation in which the reception of GNSS data 1 could be influenced by an error situation that is changing only in a limited area. Both filters preferably access a memory 10 in which the stored parameters are stored, wherein both filters preferably have separate memory areas and the slowly changing stored parameters are stored in the memory area of filter 3, while the remaining data is stored in the memory area of filter 2.

1. An operating method for determining navigation data based on global navigation satellite system GNSS data in a navigation module, the method comprising the following steps:
receiving GNSS data;
determining navigation data with the GNSS data using stored parameters saved in a memory of the navigation module which were ascertained from the GNSS data with at least one filter;
extracting a criterion from the navigation data or from another data source, which identifies a special situation in which a reception of the GNSS data is influenced by an error situation which is at least secondarily constant or has at least a constant component; and
performing updates and/or corrections of the stored parameters with the at least one filter for subsequent determinations of the navigation data,
wherein at least for parts of the stored parameters, which in principle change more slowly during operation than other of the stored parameters, the update and/or correction is slowed down or suspended when the extracted criterion indicates the special situation.

2. The method according to claim 1, wherein the special situation is a situation in which unfavorable environmental conditions for the reception of the GNSS data are present as an error situation.

3. The method according to claim 1, wherein the updating and/or correction of the stored parameters in-step-d-) is carried out using the GNSS data.

4. The method according to claim 1, wherein updated parameters and/or update parameters for the stored parameters are regularly retrieved from an external source.

5. The method according to claim 1, wherein for determining the criterion it is determined whether a start phase of the navigation module is present and the special situation is determined in the start phase of the navigation module.

6. The method according to claim 1, wherein the criterion is defined to describe the special situation describing a static scenario of operation of the navigation module.

7. The method according to claim 1, wherein to determine the criterion, a speed is first determined at which the navigation module moves and the special situation is detected when the speed is below a threshold value.

8. The method according to claim 1, wherein the stored parameters are ascertained using a main filter, and the updates and/or corrections are performed by a separate filter which is separate from the main filter.

9. The method according to claim 8, wherein at least the main filter and/or the separate filter is a Kalman filter.

10. The method according to claim 8, wherein the separate filter is slowed down when the special situation is detectable based on the extracted criterion.

11. The method according to claim 1, wherein a navigation module is configured to carry out the method.

12. The method according to claim 1, wherein a computer program product is set up to carry out the method.

13. The method according to claim 12, wherein the computer program product is stored on a non-transitory machine-readable storage medium.
